(19) United States
(12) Patent Application Publication
(10) Pub. No.: US 2010/0298452 A1
(43) Pub. Date: Nov. 25, 2010

(54) Proton-Conducting Polymer with a Two-Dimensional Backbone of Metal-Oxygen Bonding

(75) Inventors: Wen-Qing Xu, Medfield, MA (US); David Beijia Xu, Medfield, MA (US)

Correspondence Address: David Xu, 20 Hearthstone Drive, Medfield, MA, 02052, US

(73) Assignee: Hongying He, Medfield, MA (US)

(21) Appl. No.: 12/784,484

(22) Filed: May 20, 2010

Related U.S. Application Data
(60) Provisional application No. 61/180,581, filed on May 22, 2009.

(51) Int. Cl. C08J 5/22

(52) U.S. Cl. 521/27; 521/25

(57) ABSTRACT

The present invention relates a new proton-conducting polymer with a two dimensional backbone with metal-oxygen bonding. The metal ion in the backbone of the proton-conducting polymer of the present invention comprises elements from Group IIIA, IVA, VA, IIIB, IVB, VB, VIB, lanthanides, etc in the Chemical Periodic Table. It is more preferred for the metal ion of the proton-conducting polymer of the present invention to be silicon, aluminum, boron, gallium, indium, tin, antimony, bismuth, titanium, or zirconium. It is further preferred that the backbone of the proton-conducting polymer of the present invention comprises silicon, aluminum, boron, zirconium, or titanium. It is further preferred that the proton-conduction polymer of the present invention comprises silicon in its two dimensional backbone. The backbone of the proton-conducting polymer of the present invention is chemically stable to attacks from the hydroxyl free radicals in the fuel cells. The invented polymer with a two dimensional backbone of metal-oxygen bonding is thermally stable for high temperature usage as a proton-exchange membrane for proton-exchange membrane fuel cells. The polymer with a two dimensional backbone of metal-oxygen bonding is also flexible and ductile enough to allow successful fabrication of the invented material into membrane-electrode-assembly for fuel cells. The flexibility and conductivity of the proton-conducting polymer of the present invention also allow the proton-exchange membrane fuel cell to have a long lifespan with minimal issues in membrane delamination and denaturing during fuel cell operation at a high temperature.

### CROSS-REFERENCE TO PRIOR RELATED APPLICATION

This application claims benefit of the filing date of U.S. Provisional Application No. 61/180-581, filed on May 22, 2009, the entire disclosure of which is incorporated herein by reference.

### FIELD OF THE INVENTION

The present invention relates to a composition of a proton-conducting polymer with a two dimensional backbone of metal-oxygen bonding, to a membrane electrode assembly with a proton-exchange membrane comprising the proton-conducting polymer, and to a fuel cell comprising the assembly.

### BACKGROUND OF THE INVENTION

It is highly anticipated that proton-exchange membrane fuel cells, along with other type of fuel cells such as solid oxide fuel cells, molten carbonate fuel cells, phosphoric acid fuel cells, etc., will be put into practical use for applications such as household power generation; clean power-generating devices for automobiles; back-up power generation for military, hospitals, schools, etc.; and stationary power plants for commercial power supplies that allow for green power generation. Such fuel cells are fueled by hydrogen and oxygen. Direct methanol fuel cells (DMFC) have also been proposed, in which methanol is used in place of hydrogen for fuel. DMSC is expected to replace lithium secondary batteries as high-capacity batteries for mobile devices and are now studied intensively in the art.

The important functions of the proton-exchange membrane as an electrolytic membrane for proton-exchange membrane fuel cells are (1) to physically insulate the fuel (e.g., hydrogen, aqueous methanol solution) that is fed to the anode from the oxidizing gas (e.g., oxygen) that is fed to the cathode, (2) to electrically insulate the anode from the cathode, and (3) to transmit the proton formed on the anode to the cathode in order to react with oxygen to form water. To fulfill these functions, the proton-exchange membrane must have both mechanical strength and proton conductivity.

The proton-exchange membrane for proton-exchange membrane fuel cells is generally a perfluorocarbon polymer with non-aromatic sulfonic acid functional groups, such as Nafion™, which is comprised of sulfonic acid groups with a carbon-carbon backbone. This type of perfluorocarbon proton-exchange membrane of the type has good ionic conductivity and relatively high mechanical strength, but has some problems that need to be resolved. Concretely, in the proton-exchange membrane, water and the sulfonic acid group form cluster channels, and protons move in the cluster channels via the water therein. Therefore, the ionic conductivity of the membrane is highly dependent on its water content, which is associated with the humidity in the service environment in which the cells are driven. In order to reduce the CO poisoning effect on the catalyst electrode and to facilitate the activation of the catalyst electrode therein, solid polymer fuel cells are preferably driven at a temperature ranging from 100 to 150° C. The US Department of Energy has established a guideline for proton-exchange membrane fuel cells to operate at target conditions of 120° C. and 50% relative humidity and a goal of 0.1 mS/cm for the proton conductivity. However, such a temperature range results in the lowering of the water content of the proton-exchange membrane in the cells as well as a reduction in the proton conductivity of perfluorocarbon membrane; this can cause problems, as fuel cells with perfluorocarbon membranes cannot deliver the expected cell characteristics. In addition, the softening point (a glassy transition temperature, T_{g}) of the perfluorocarbon membrane is around 120° C. When the cells are driven at a temperature around it, another issue that arises is that the mechanical strength of the electrolytic membrane is unsatisfactory. Water affects the mechanical properties of the membrane by acting as a plasticizer, further lowering the T_{g} and modulus of the membrane. In the vicinity of this temperature, a phenomenon known as creep occurs. As a result, the proton conduction structure in the membrane changes, making it impossible to attain stable proton conduction performance. Furthermore, the membrane is denatured to a swollen state that becomes jelly-like after prolonged exposure to high temperature and can easily break, leading to the failure of the fuel cell. When a proton exchange membrane is used in DMFC, it causes other problems. The membrane readily absorbs water and its barrier ability against the fuel methanol is not favorable. Therefore, methanol that has been fed to the anode diffuses through the proton-exchange membrane to reach the cathode and reacts at the cathode with the oxidant. Due to this, the cell output power lowers; this is referred to as the methanol-crossover phenomenon, which is a serious problem for the practical use of DMFC. Furthermore, there are hydroxyl free radicals at the cathode during the fuel cell operation. These hydroxyl free radicals lead to the accumulation of hydrogen peroxide at the cathode to a level that can be as high as a few percent after the fuel cell operates for an extended period of time. The free radical attack from hydrogen peroxide on the proton-exchange membrane can be very severe under fuel cell operating conditions, particularly when fuel cells operate at a region of middle and high temperatures. Free radicals prefer to attack the tertiary carbon on the carbon-carbon backbone of the polymers and reduce the molecular weight of the polymers, resulting in the degradation of the proton-exchange membrane. Fluorination of the carbon-carbon backbone of the proton-exchange membrane reduces the problem of free radical degradation, but cannot completely eliminate it.

Therefore, Nafion™ and other similar fluorinated carbon-carbon backbone polymers from DuPont, Asahi Chemical, Dow, etc. and other analogs such as sulfonated and fluorinated polystyrene from Ballard and Dais Analytical are not able to address the needs of fuel cells to meet the needs in (1) high proton conductivity, (2) low electric conductivity, (3) low permeability to fuel and oxidants, (4) low water transport through diffusion and electro-osmosis, (5) high oxidative and hydrolytic stability, (6) good mechanical properties in both dry and hydrated states, (7) cost, and (8) capability for fabrication into membrane electrode assemblies (MEAS).

In searching for better proton-exchange membrane for fuel cells, poly(arene ether)s have been proposed. In this type of polymer, the backbone of the polymers is mainly based on aromatic rings that are connected by oxygen and/or sulfur atoms in ether forms. Other efforts involve sulfon groups that are incorporated into the backbone that connects aromatic and aliphatic backbones blocks of the polymers. Polyimide and polyphosphazen are other types of proton-conducting polymers that have been explored in prior art. Researchers have been approaching these tough issues for fuel cell proton-exchange membrane by trying to incorporate aromatic, oxygen, sulfur, nitrogen, and phosphorus atoms or groups into the backbones of the polymers to improve chemical stability against the free radical attacks. However, none of these approaches were able to shield the proton-conducting polymers from damage caused by the free radical attacks of hydrogen peroxide on the backbone of the polymers, as the backbones of these different polymers are still either partially or completely comprised of carbon-carbon chains.

In addition, the new membrane materials for proton-exchange membrane fuel cells must be fabricated into a well-bonded, robust membrane electrode assembly (MEA). Beyond the material requirements of the proton-exchange membrane itself outlined above, the convenient fabrication of the membrane electrode assembly and the resulting properties of the MEA are also critical. Current work in the area of fabricating MEAs from novel polymeric membranes has focused upon the electrode-membrane interface and the issues that face the membranes as components of the electrode. Novel membranes must also be adaptable and have the necessary physical strength and ductivity in both dry and wet states in order to survive the stress of electrode attachment for many cycles of cold and hot temperatures throughout the lifespan of the fuel cell operation.

Given that situation, there is an urgent need for the development of other proton-conductive materials that can substitute Nafion™ and similar electrolytic materials as proton-exchange membranes for fuel cells. For example, the proton-conductive glass-like material is disclosed for inorganic proton-conductive materials and organic-inorganic proton-conductive materials (for example, see U.S. Pat. No. 7,371,480; U.S. Patent Application US2006/0035129; Publication by G. Alberti and M. Casiola, Ann. Rev. Mat. Res. 2003, 33, 129). These types of proton-exchange membranes are obtained through the polymerization of tetraalkoxysilane and other silanes in the presence of acid or base in a sol-gel process in combination with the post-oxidation of mercapto groups to sulfonic acid or post-sulfonation of aromatic rings to form sulfonic acid groups. It is known that its humidity dependency is low in a high-temperature range. However, the glass-like material is not flexible and is extremely brittle; large-area membranes are difficult to produce from it. Therefore, the glass-like material is unsuitable for usage as electrolytic material for fuel cells. For easy film formation based on the favorable characteristics of inorganic material, one proposal is a nanocomposite material hybridized with polymer material. For example, the hybridization of a polymer compound having a sulfonic acid group in the side branches and a silicon oxide has been proposed as a method for forming a proton-exchange membrane. Another proposal is an organic-inorganic nanohybrid proton-conductive material that is obtained through sol-gel reaction of a precursor, organic silicon compound in the presence of an acid, by Kiyoharu Tadanaga, Hiroshi Yoshida, Atsunori Matsuda, Tsutomu Minami, and Masahiro Tatsumisago, “Preparation of Proton-Conductive Inorganic-Organic Hybrid Films from 3-Glycidoxypropyltrimethoxysilane and Orthophosphoric Acid”, Chem. Mater., 2003, 15 (9), pp 1910-1912.). The proton conducting membrane crosslinked by silicon-oxygen linkages, which is characterized by a fact that it bears a carbon-containing organic-inorganic composite structure covalently bonded to plural silicon-oxygen crosslinks (three dimensional) and an acid-containing structure having acid groups. These organic-inorganic composite and hybrid proton-conductive materials comprise an inorganic component and an organic component, in which the inorganic component comprises silicic acid and proton acid and serves as a proton-conductive site and the organic component serves to make the materials flexible. When the inorganic component is increased so as to increase the proton conductivity of the membranes of the formed material, the mechanical strength of the membranes lowers. Likewise, the proton conductivity of the membranes lowers when the organic component is increased so as to increase the flexibility of the membranes. Hence, materials that satisfy both characteristics are difficult to obtain.

### SUMMARY OF THE INVENTION

The prior art disclosed that inorganic or inorganic-organic membranes are usually cross-linked by silicon-oxygen bonds in three dimensions in a manner similar to a brittle and rigid glass, which is not desirable.

The first embodiment of this invention is the proton-conducting polymer comprised of a backbone comprising two-dimension metal-oxygen bond. This mainly two-dimensional polymer is flexible and ductile when in wet or dry condition as opposed to the three-dimensional cross-linked proton-conducting materials with metal-oxygen bonds in the prior art that are rigid and non-ductile. The metal ions in the proton-conducting polymer of the present invention comprise elements from Group IIIA, IVA, VA, IIIB, IVB, VB, VIB, lanthanides, etc. The metal ions in the polymer of the present invention may be one pure metal ion or a mixture of these metal ions. It is more preferred that the metal ion/ions of the polymer comprise silicon, aluminum, boron, gallium, indium, tin, antimony, bismuth, titanium, or zirconium. It is further preferred that the backbone of the proton-conducting polymer of the present invention comprises silicon, aluminum, boron, zirconium, or titanium. It is further preferred that the proton-conduction polymer of the present invention comprises silicon. The backbones of these polymers can also be doped with any other element(s) in the Periodic Table of Chemical Elements. The metal-oxygen backbone of the proton-conducting polymers of the present invention is highly stable chemically. Such a backbone, unlike the backbone of carbon-carbon bonds in the other proton-conducting polymers in the prior art, will not suffer damages from the attacks of free hydroxyl radicals that are usually generated and accumulated in the cathode during the operation of the fuel cell. Such a backbone of the proton-conducting polymer of the present invention will have superior thermal stability compared to the carbon-carbon bond proton-conducting materials of the prior art. The silicon-oxygen bonds are expected to retain their stability well beyond the operating temperature at that proton-exchanged membrane fuel cells typically function.

The second embodiment of the proton-conducting polymers of the present invention is the functional group that attaches to the backbone of the proton-conducting polymers. It is preferred for the functional group that attaches to these proton-conducting polymers to be comprised of proton-bearing groups. It is preferable for the proton-bearing functional group in the proton-conducting polymer of the present invention to be comprised of sulfonic acid groups, carboxylic acid, and/or phosphonic acid. It is further preferred that functional groups that attach to the proton-conducting polymer of the present invention are comprised of sulfonic acid.

The third embodiment of the proton-conducting polymers of the present invention is the precursor to the proton-bearing functional groups. Any sulfur-containing functional groups that can be converted to sulfonic acid group are within the scope of the present invention. Any functional groups that can incorporate sulfonic acids, such as aromatics that can be sulfonated into sulfonic acids, are also within the scope of the present invention. Any functional groups that can be converted to carboxylic acid groups are also with the scope of the present invention. Any phosphorus-containing functional groups that can be converted to phosphonic acid group are within the scope of the present invention. Any functional groups that can incorporate phosphonic acids are also with the scope of the present invention.

The fourth embodiment of the proton-conducting polymers of the present invention comprises the processes converting the functional groups on the precursor of the proton-conducting polymers of the present invention into proton-bearing functional groups. Such process may include, but are not limited to, the oxidation of mercapto-containing functional groups for the formation of sulfonic acid groups, sulfonation of phenyl or aromatic functional groups to sulfonic acid groups, oxidation of different functional groups to carboxylic acid groups, etc.

The fifth embodiment of the present invention is that the proton-conducting polymer material comprises different types of functional groups to control the hydrophobicity in addition to the presence of proton-bearing functional groups. Such functional groups comprise hydrocarbon groups or heteroatom-substituted hydrocarbon groups that can create different degrees of hydrophobicity. Such hydrocarbon or heteroatom-substituted hydrocarbon groups may contain 1 to 30 carbons that can be aromatic or aliphatic. Fine-tuning the hydrophobicity of the proton-conducting polymer of the present invention will be used to control the barrier properties of the fuel, such as the methanol in the fuel cell so that the crossover problem can be minimized.

The sixth embodiment of the present invention is controlling different amounts of proton-bearing functional groups to control the concentration of protons in the polymer of the present invention. Doing so will allow for the fine-tuning of the proton conductivity for optimal proton-conductivity in the proton-exchange membrane for the fuel cell while balancing other physical properties of the polymer for optimal performance in fuel cells.

The seventh embodiment of the present invention is that the proton-conducting polymers comprise at least three or more metal ions in the polymer chain's backbone. The number of metal ion(s) on the chain of the proton-exchange polymer of the present invention can be varied in order to control the polymer's molecular weight, which will allow for the manipulation of the physical properties of the proton-exchange membrane. The proton-conducting polymer with two-dimension backbone of metal-oxygen bond in the present invention is expected to be a ductile material that is either amorphous or crystalline. The ductivity of the proton-conducting polymer of the present invention facilitates the fabrication of MEAs that do not suffer damages resulting from stress during fuel cell operation, such as the stress caused by thermal expansion and contraction during cell operation at low and high temperature cycles.

The eighth embodiment of the present invention is that the proton-conducting polymer comprises a solid, dispersion, or a solution in different solvent environments. These solvents may include water, alcohol, ketones, hydrocarbons, halocarbons, esters, ethers, or other heteroatom-substituted or heteroatom-containing hydrocarbon solvents. The water-borne or solvent-borne proton-conducting polymer of the present invention can then be coated on different substrates to form proton-exchange membrane for fuel cells.

The ninth embodiment of the present invention is that the proton-conducting polymer can also be made into membrane by extrusion, molding, or other membrane-forming or film-forming techniques.

The tenth embodiment of the present invention is that the proton-exchange membrane of the present invention can also be made from the film or membrane that is made from its precursor(s) followed by post-treatment of this precursor for the formation of the proton-bearing functional groups that attach to the polymer chain. Such post-treatments, such as the oxidation of mercapto-functional group to sulfonic acid and sulfonation of the aromatic ring to produce sulfonic acid group-containing proton-conducting material, are also within the scope of the present invention.

The eleventh embodiment of the present invention is that the proton ions in the proton-conducting polymer of the present invention may be partially or completely replaced by other cations, such as ammonium ions, alkali metal ions, alkaline earth metal ions, etc.

The twelve embodiment of the present invention is that the proton-conducting polymer of the present invention may be filled with other filler particles including micron-sized particles, sub-micron particles, and nano-sized particles. This could be done in order to achieve improvements in proton conductivity, electrical properties, physical properties, and durability, etc.

The thirteenth embodiment of the present invention is the proton-conducting polymer of the present invention comprises hetero-atom(s) substituted functional groups that attach to the backbone of the polymer. Such a hetero-atom comprises pure elements from Group VA, VIA, and VIIA or a mixture of these elements. More preferably, this hetero-atom comprises nitrogen, phosphorus, oxygen, sulfur, fluorine, chlorine, bromine, or iodine, etc. Substitution of any elements of the functional group in the polymer of the present invention may further improve the chemical, thermal, and mechanical properties of the polymer of the present invention.

### DETAILED DESCRIPTION OF THE INVENTION

Fuel cells have the potential to become an important energy generating technology. The thrust for the commercialization of fuel cells involves enormous efforts towards developing a hydrogen-based energy economy that will lead to independence from foreign oil and a reduction in the pollution of environment. Proton exchange membrane fuel cells using a solid polymer electrolyte to separate the fuel and the oxidant were first used in the Gemini space program in the early 1960s. The cells used sulfonated polystyrene-divinylbenzene copolymer membrane as a proton-conducting electrolyte. The benzene rings that carried the substituted sulfonic acid groups were attached to the tertiary carbon atoms on the carbon-carbon backbone of the polymers. However, the cells were short-lived due to oxidative degradation of the sulfonated styrenic copolymers with carbon-carbon backbones. Because of limited diffusion, there were hydroxyl free radicals near the cathode. The existence of the hydroxyl free radicals accumulated to generate significant amounts of hydrogen peroxide over time. The concentration of hydrogen peroxide may reach a few weight percentages in the region near the cathode. Such a high concentration of hydrogen peroxide is highly active and oxidative. The tertiary carbon atoms on the carbon-carbon chain of the proton-conductive polymer are highly susceptible to the attack by hydroxyl free radicals. This results in the scission of the carbon-carbon backbone of the proton-conducting membrane of the sulfonated polystyrenic copolymers. Eventually, such carbon-carbon chain scissions lead to the degradation of the proton exchange membrane to a level where the fuel cells can no longer function. Temperature is another factor that affects the oxidative activity of the hydroxyl groups. The higher the temperature, the more severe the hydroxyl free radical attack becomes. Therefore, sulfonated polystyrenic materials with carbon-carbon backbones are not desirable materials for proton exchange membrane for fuel cells.

In addition, a higher operation temperature is desirable in order for fuel cells to function with a high efficiency. Precious metal electrodes in Proton-Exchanged Membrane Fuel cells operating at low temperatures are easily poisoned by the presence of impurities in the fuel, such as carbon monoxide. Therefore, a higher temperature for the fuel cell operations is desirable to prevent the poisoning of the precious metal on the electrode and to keep the usage of the precious metal to a level that is economically feasible. Specifically, the department of energy has currently established target operating conditions of 120° C. and 50% relative humidity.

Fluorination of proton-conducting polymers, such as Nafion from DuPont and other perfluorinated non-aromatic proton-conducting materials (Aciplex from Asahi Chemical, Flemion from Asahi Glass, and Dow's materials), improves the chemical and thermal stability of the proton exchange membrane. However, the glassy transition temperature of the perfluorinated proton-conducting polymers, such as Nafion™, is between 109 to 120° C. When the operating temperature of the fuel cells approaches the glassy transition temperature, the perfluorinated proton-exchange membrane becomes brittle and denatured so it is no longer able to perform as a reliable proton-conducting polymer. Nafion™ proton-conducting membranes typically operate at around 80° C. Therefore, the most popular proton-exchange membrane from DuPont cannot meet the needs of the future high efficiency high temperature proton-exchange membrane fuel cells. Furthermore, DuPont's Nafion™ proton-conducting polymer is highly expensive.

Ballard Advanced Materials Corporation developed backbone-fluorinated polystyrene sulfonic acid polymers that mimic DuPont's Nafion materials except that Ballard materials containing sulfonic acid on the benzene rings that are attached to the fluorinated carbon-carbon backbone chain. Such fluorination was no doubt intended to mitigate hydroxyl radical attacks on the tertiary carbon on the carbon-carbon chain. Crystallinity and physical properties are definitely concern for Ballard's fluorinated polystyrenic proton-exchange membranes.

Dais Analytic's proton-conducting membranes were based on the poly-styrene copolymers with styrene-ethylene/styrene-butylene family. Such proton-conducting polymers can only function at relatively low temperatures, usually less than 60° C. The hydroxyl free radicals accumulated in the fuel cells definitely attack the backbone of this polystyrene to make this type of membrane material have a shorter operational life.

In the research community, poly(arylene ether) polymers have been proposed to work as proton-conducting polymers that may have better tolerance to hydroxyl free radical attacks. The aromatic rings are connected either by ether functional groups like oxygen and sulfur or by sulfone, ketone, phosphone groups, and 2,2-propylene groups (fluorinated or none-fluorinated methyl groups). The idea behind all of these materials was to incorporate relatively more stable aromatic rings into the backbone and to minimize the tertiary carbon atoms that are susceptible to the attacks from hydroxyl free radicals. However, these materials do not seem to solve the outstanding problems and meet the tough needs for high temperature proton-exchange membrane fuel cells. Polyimides and polyphosphazene polymers have also been proposed in the art by introducing hetero-atoms into the polymer backbone or substituted groups of the polymers. However, none of these materials can perform on par with DuPont's perfluorinated proton-exchange membrane materials, Nafion™.

Subsequently, researchers have approached such issues by proposing the usage of sol-gel processed inorganic-organic composite proton-exchange membranes. In these sol-gel processes, mercaptan-containing silanes are hydrolyzed to sols. Either in combination with other organic polymers or by itself, these types of sols are used to form membranes by forming a three-dimensional cross-linking network with oxygen and silicon bonds. The mercaptan groups can then be converted to sulfonic acid groups by oxidation with hydrogen peroxide or other oxidation agents. These proton-exchanged membranes have a drastically better ability to operate at higher temperatures and are better able to tolerate attacks by hydroxyl free radicals, simply because the tertiary carbon backbone does not exist in the polymer system. This type of work has been taught in the art (for example, U.S. Pat. No. 7,371,480; U.S. Patent Application US2006/0035129; Publication by G. Alberti and M. Casiola, Ann. Rev. Mat. Res. 2003, 33, 129). However, this three-dimensional cross-linking network induces the rigidity of the polymers as proton-exchange membranes. Hence, there are two different drawbacks for their usage as proton-conducting membranes: (1) it is difficult to form membranes with good ductivity for membrane-electrode assembly, and (2) delamination problems are caused by unmatched thermo-expansion co-efficiencies between the membranes and the materials for membrane electrode assembly during their heating and cooling cycles of the fuel cells.

Given the above needs, the following describes the proton-conducting materials of the present invention as proton-exchange membranes for fuel cells in more detail:

The first embodiment of this invention is the proton-conducting polymer comprised of a backbone comprising two-dimension metal-oxygen bond. This mainly two-dimensional polymer is flexible and ductile when in wet or dry condition as opposed to the three-dimensional cross-linked proton-conducting materials with metal-oxygen bonds in the prior art that are rigid and non-ductile. The metal ions in the proton-conducting polymer of the present invention comprise elements from Group IIIA, IVA, VA, IIIB, IVB, VB, VIB, lanthanides, etc. The metal ions in the polymer of the present invention may be one pure metal ion or a mixture of these metal ions. It is more preferred that the metal ion/ions of the polymer comprise silicon, aluminum, boron, gallium, indium, tin, antimony, bismuth, titanium, or zirconium. It is further preferred that the backbone of the proton-conducting polymer of the present invention comprises silicon, aluminum, boron, zirconium, or titanium. It is further preferred that the proton-conduction polymer of the present invention comprises silicon. The backbones of these polymers can also be doped with any other element(s) in the Periodic Table of Chemical Elements. The metal-oxygen backbone of the proton-conducting polymers of the present invention is highly stable chemically. Such a backbone, unlike the backbone of carbon-carbon bonds in the other proton-conducting polymers in the prior art, will not suffer damages from the attacks of free hydroxyl radicals that are usually generated and accumulated in the cathode during the operation of the fuel cell. Such a backbone of the proton-conducting polymer of the present invention will have superior thermal stability compared to the carbon-carbon bond proton-conducting materials of the prior art. The silicon-oxygen bonds are expected to retain their stability well beyond the operating temperature at that proton-exchanged membrane fuel cells typically function.

The second embodiment of the proton-conducting polymers of the present invention is the functional group that attaches to the backbone of the proton-conducting polymers. It is preferred for the functional group that attaches to these proton-conducting polymers to be comprised of proton-bearing groups. It is preferable for the proton-bearing functional group in the proton-conducting polymer of the present invention to be comprised of sulfonic acid groups, carboxylic acid, and/or phorsphonic acid. It is further preferred that functional groups that attach to the proton-conducting polymer of the present invention are comprised of sulfonic acid.

The third embodiment of the proton-conducting polymers of the present invention is the precursor to the proton-bearing functional groups. Any sulfur-containing functional groups that can be converted to sulfonic acid group are within the scope of the present invention. Any functional groups that can incorporate sulfonic acids, such as aromatics that can be sulfonated into sulfonic acids, are also within the scope of the present invention. Any functional groups that can be converted to carboxylic acid groups are also with the scope of the present invention. Any phosphorus-containing functional groups that can be converted to phosphonic acid group are within the scope of the present invention. Any functional groups that can incorporate phosphonic acids are also with the scope of the present invention.

The fourth embodiment of the proton-conducting polymers of the present invention comprises the processes converting the functional groups on the precursor of the proton-conducting polymers of the present invention into proton-bearing functional groups. Such process may include, but are not limited to, the oxidation of mercapto-containing functional groups for the formation of sulfonic acid groups, sulfonation phenyl functional groups to sulfonic acid groups, oxidation of different functional groups to carboxylic acid groups, etc.

The fifth embodiment of the present invention is that the proton-conducting polymer material comprises different types of functional groups to control the hydrophobicity in addition to the presence of proton-bearing functional groups. Such functional groups comprise hydrocarbon groups or heteroatom-substituted hydrocarbon groups that can create different degrees of hydrophobicity. Such hydrocarbon or heteroatom-substituted hydrocarbon groups may contain 1 to 30 carbons that can be aromatic or aliphatic. Fine-tuning the hydrophobicity of the proton-conducting polymer of the present invention will be used to control the barrier properties of the fuel, such as the methanol in the fuel cell so that the crossover problem can be minimized.

The sixth embodiment of the present invention is controlling different amounts of proton-bearing functional groups to control the concentration of protons in the polymer of the present invention. Doing so will allow for the fine-tuning of the proton conductivity for optimal proton-conductivity in the proton-exchange membrane for the fuel cell while balancing other physical properties of the polymer for optimal performance in fuel cells.

The seventh embodiment of the present invention is that the proton-conducting polymers comprise at least three or more metal ions in the polymer chain's backbone. The number of metal ion(s) on the chain of the proton-exchange polymer of the present invention can be varied in order to control the polymer's molecular weight, which will allow for the manipulation of the physical properties of the proton-exchange membrane. The proton-conducting polymer with two-dimension backbone of metal-oxygen bond in the present invention is expected to be a ductile material that is either amorphous or crystalline. The ductivity of the proton-conducting polymer of the present invention facilitates the fabrication of MEAs that do not suffer damages resulting from stress during fuel cell operation, such as the stress caused by thermal expansion and contraction during cell operation at low and high temperature cycles.

The eighth embodiment of the present invention is that the proton-conducting polymer comprises a solid, dispersion, or a solution in different solvent environments. These solvents may include water, alcohol, ketones, hydrocarbons, halocarbons, esters, ethers, or other heteroatom-substituted or heteroatom-containing hydrocarbon solvents. The water-borne or solvent-borne proton-conducting polymer of the present invention can then be coated on different substrates to form proton-exchange membrane for fuel cells.

The ninth embodiment of the present invention is that the proton-conducting polymer can also be made into membrane by extrusion, molding, or other membrane-forming or film-forming techniques.

The tenth embodiment of the present invention is that the proton-exchange membrane of the present invention can also be made from the film or membrane that is made from its precursor(s) followed by post-treatment of this precursor for the formation of the proton-bearing functional groups that attach to the polymer chain. Such post-treatments, such as the oxidation of mercapto-functional group to sulfonic acid and sulfonation of the aromatic ring to produce sulfonic acid group-containing proton-conducting material, are also within the scope of the present invention.

The eleventh embodiment of the present invention is that the proton ions in the proton-conducting polymer of the present invention may be partially or completely replaced by other cations, such as ammonium ions, alkali metal ions, alkaline earth metal ions, etc.

The twelfth embodiment of the present invention is that the proton-conducting polymer of the present invention may be filled with other filler particles including micron-sized particles, sub-micron particles, and nano-sized particles. This could be done in order to achieve improvements in proton conductivity, electrical properties, physical properties, and durability, etc.

The thirteenth embodiment of the present invention is the proton-conducting polymer of the present invention comprises hetero-atom(s) substituted functional groups that attach to the backbone of the polymer. Such a hetero-atom comprises pure elements from Group VA, VIA, and VIIA or a mixture of these elements. More preferably, this hetero-atom comprises nitrogen, phosphorus, oxygen, sulfur, fluorine, chlorine, bromine, or iodine, etc. Substitution of any elements of the functional group in the polymer of the present invention may further improve the chemical, thermal, and mechanical properties of the polymer of the present invention.

The precursors of the proton-exchange polymers of the present invention comprise two-dimensional metal-oxygen bonded polymers such as silicone oils. Examples of these silicone oils are Dow Corning's methyl phenyl siloxane 510 Fluid (50 CST, 100 CST, 500 CST, and 30,000 CST), 550 Fluid, 710 Fluid, 710 R Fluid, 2-2078 Fluid, 556 Fluid, and ET-4327 Fluid as well as Dow Corning's phenyl-containing greases: Molykote 33 (low temperature bearing grease), Molykote 41 (extreme high temperature bearing grease), Molykote 44, Molykote 55 (O-Ring Grease), and Molykote 822M (grease). Dow Corning 705 (pentaphenyltrimethyltrisiloxane) and Dow Corning 704 (tetramethyltetrapheyltrisiloxane) as diffusion pump oil are also examples of these silicones. These phenyl-containing silicone oils can then be sulfonated to the proton-conducting materials of the present invention.

The present invention is further embodied in the following examples, but the scope of the present invention is not limited to these examples.

### EXAMPLES

### Example 1

Silicone oil (Dow Corning 710, 500 cp, 10 grams) was weighed into a 100 mL beaker. Mineral Spirit (40 mL) was added into the above beaker. Under magnetic stirring, 10 grams of chlorosulfonic acid were dripped into above Silicone-Mineral Spirit solution. The solution turned brown with an emission of white smoke. The brown color got deeper with the addition of chlorosulfonic acid. The white smoke was mainly hydrochloric acid. The mixture was continuously stirred for another 1 hour and 20 minutes. The mixing was stopped and 2 separate layers formed. The top layer was clear with Mineral Spirit and bottom layer was the proton-conducting polymer of the present invention containing a silicone-oxygen backbone to which sulfonic acid groups were attached.

The obtained proton-conducting polymer (1 gram) was diluted with about 100 mL of distilled water. The pH was found to be about 2.2. It took 2.89 grams of 1.0N NaOH to neutralize the diluted proton-conducting polymer of the present invention.

The obtained proton-conducting polymer was not compatible with 70% ethanol solution, isopropanol solution, or isobutyl-ketone solution. However, it seems to be compatible with methyl ethyl ketone solution. The rest of the obtained proton-exchanged polymer of the present invention was diluted with methyl-ethyl ketone (about 10 mL). After a few days, chunks of clear solid gel formed and floated in the methyl-ethyl ketone medium. The ketone solution was still yellowish. Such yellowish material may very well be sulfonic acids that were formed during the sulfonation process via sulfonation of aromatic impurities in Mineral Spirit by chlorosulfonic acid. The solid clear gel was separated and left in a drying dish in the air overnight. After evaporation of the solvent, the solid clear gel turned into a ductile and rubbery whitish material.

### Example 2

Silicone oil (Dow Corning 510, 30,000 cp, 10 grams) was weighed into a 200 mL beaker. Mineral Spirit from Home Depot (100 mL) was added into above beaker. Under magnetic stifling, 10 grams of chlorosulfonic acid were dripped into above Silicone-Mineral Spirit solution. The solution turned brown with an emission of white smoke. The brown color got deeper during the process of addition of chlorosulfonic acid. The white smoke was mainly hydrochloric acid. The mixture was continuously stirred for another 1 hour and 20 minutes. The mixing was stopped and 2 separate layers formed. The top layer was clear with Mineral Spirit and bottom layer was the proton-conducting polymer of the present invention containing a silicone-oxygen backbone to which sulfonic acid groups were attached.

Dried small amount of the bottom player material on a glass dish in air overnight and it turned into a solid.

Weighed 1.33 grams of the above bottom layer material and added 0.67 grams isopropanol; it was found that the bottom layer material was not compatible with isopropanol. Adding additional 0.67 gram of isopropanol still did not make it compatible with isopropanol. Adding 0.67 gram of methyl-ethyl ketone still did not make them compatible.

Weighed 1.0 gram of the above bottom layer material and added 1.0 gram of water; a precipitate formed. Weighed 1.0 gram of the above bottom layer material and added 0.5 gram of methyl isobutyl ketone; a precipitate formed. Addition of additional 0.5 gram of methyl-isobutyl ketone did not seem to help to dissolve the precipitate.

Weighed 1.0 gram of bottom layer material and added 0.5 grams of methyl-ethyl ketone; it was found that they were compatible. Dripping one drop of such solution on an index paper card, methyl-ethyl ketone evaporated and left behind a spotty coating. Added additional 0.5 gram of methyl-ethyl ketone and shook it. Dripping one drop of such solution on an index card paper, MEK evaporated and left a continual film. Dripped a small drop of water on resulting coating, water disappear quickly.

After the first coating, second and third coating can be further applied. The coating seems to be rubbery and resilient to touch.

The obtained bottom layer proton-conducting polymer (1 gram) was diluted with about 100 mL distilled water. After mixing with magnetic stirrer, it turned into a stable and cloudy colloid. The pH was found to be about 1.8. It took 7.65 grams of 1.0N NaOH to neutralize the diluted proton-conducting polymer of the present invention. The colloid remained stable after the titration.

### FULL CITATIONS FOR REFERENCES

1. Michael A. Hickner, Hossein Ghassemi, Yu Seung Kim, Brian R. Einsla, and James E. McGrath, “Alernative Poymer System for Proton Exchange Membranes (PEMs)”, Chem. Rev. 2004, 104, 4587-4612.

2. G. Alberti and M. Casiola, Ann. Rev. Mat. Res. 2003, 33, 129.

3. Kiyoharu Tadanaga, Hiroshi Yoshida, Atsunori Matsuda, Tsutomu Minami, and Masahiro Tatsumisago, “Preparation of Proton-Conductive Inorganic-Organic Hybrid Films from 3-Glycidoxypropyltrimethoxysilane and Orthophosphoric Acid”, Chem. Mater., 2003, 15 (9), pp 1910-1912.

4. Shigeki Nomura, Kenji Yamauchi, Satoshi Koma, Toshiya Sugimoto, and Taira Hasegawa, “Proton Conducting Membrane, Method for Producing the Same and Fuel Cell Using the Same”, U.S. Patent Application, Pub. No.: US 2006/0035129 A1, Feb. 16, 2006.

5. Siwen Li, Meilin Liu, Kohei Hase, Masatsugu Nakanishi,; Shizuoka; Wen Li, and Junzo Ukai, “Phosphonic-acid grafted hybrid inorganic-organic proton electrolyte membranes (PEMs)”, U.S. Pat. No. 7,183,370, Feb. 27, 2007.

6. Hae-kyoung Kim, Jae-sung Lee, Chang-houn Rhee, and Hyuk Chang, “Polymer Nanocomposite Membrane And Fuel Cell Using The Same”, U.S. Pat. No. 7,368,198, May 6, 2008.

7. Michio Ono, Koji Wariishi, Kimiatsu Nomura, and Wataru Kikuchi, “Silica Sol Composition, Membrane Electrode Assembly with Proton-Exchange Membrane, and Fuel Cell”, U.S. Pat. No. 7,371,480, May 13, 2008.

8. Nawal Kishor Mal, Koichiro Hinokuma, and Kazuhiro Noda, “Hybrid Silica Polymer, Method For Production Thereof, And Proton-Conducting Material”, U.S. Pat. No. 7,524,916, Apr. 28, 2009.

We claimed:

1. A proton-conducting polymer comprising a backbone of two-dimensional metal-oxygen bonds.

2. The metal ion, in claim 1, in the backbone of the proton-conducting polymer comprises silicon.

3. The backbones of these polymers in claim 1 and 2 can also be doped with any other element(s) in the Periodic Table of Chemical Elements.

4. The functional group(s) that attach to the backbone of the proton-conducting polymers in claim 1 to 4 comprise(s) proton-bearing groups.

5. The proton-bearing functional group in the proton-conducting polymer in claim 5 comprises sulfonic acid groups.

6. The process of making the proton-conducting polymer in claim 1-5 comprises the oxidation of mercapto-containing functional groups for the formation of sulfonic acid groups.

7. The process in making the proton-conducting polymer in claim 1-5 comprises the sulfonation of phenyl functional groups to sulfonic acid groups.

8. The proton-conducting polymer in claims 1 to 7 comprises at least three or more metal ions in the polymer chain's backbone.

9. The precursor of the proton-exchange polymers in claim 1 to 8 comprises two-dimensional metal-oxygen bonded polymers such as silicone oils. The example of silicone oils in claim 1 to 8 comprises Dow Corning's methyl phenyl siloxane 510 Fluid (50 CST, 100 CST, 500 CST, 30,000 CST), 550 Fluid, 710 Fluid, 710 R Fluid, 2-2078 Fluid, 556 Fluid, or ET-4327 Fluid. The example of silicone oils in claim 1 to 10 also comprises Dow Corning's phenyl-containing greases: Molykote 33 (low temperature bearing grease), Molykote 41 (extreme high temperature bearing grease), Molykote 44, Molykote 55 (O-Ring Grease), or Molykote 822M (grease). The example of silicone oils in claim 1 to 8 also comprises Dow Corning 705 (pentaphenyltrimethyltrisiloxane) or Dow Corning 704 (tetramethyltetrapheyltrisiloxane) as diffusion pump oil. These phenyl-containing silicone oils can then be sulfonated to the proton-conducting materials of the present.

10. Proton-Exchange Membrane comprising the proton-conducting polymer from claim 1 to claim 9.

11. Proton-Exchange Membrane Fuel Cell comprising the proton-conducting polymer claim 1 to claim 9.

12. Solid acid comprising the proton-conducting polymer from claim 1 to claim 9 can act as a solid acid catalyst for different catalytic processes.
